(19) United States
(12) Patent Application Publication
(10) Pub. No.: US 2021/0202188 A1
(43) Pub. Date: Jul. 1, 2021

(54) Luminous Light Switch Assembly

(71) Applicant: Eric Benden, Rancho Cucamonga, CA (US)

(72) Inventor: Eric Benden, Rancho Cucamonga, CA (US)

(21) Appl. No.: 16/728,520

(22) Filed: Dec. 27, 2019

(51) Int. Cl. H01H 9/18; H01H 23/14; F21S 8/00

(52) U.S. Cl. CPC H01H 9/185; F21S 8/035; H01H 9/182; H01H 23/141

(57) ABSTRACT

A luminous light switch assembly for illuminating a light switch in a darkened room includes a wall plate that is mountable to a wall having the wall plate being aligned with a switch opening in the wall. A switch is positionable in the switch opening and the switch is wired into a light circuit for turning the light circuit on and off. Moreover, the switch has a fluorescent condition such that the switch is visible in a darkened environment. includes a wall plate that is mountable to a wall having the wall plate being aligned with a switch opening in the wall. A switch is positionable in the switch opening and the switch is wired into a light circuit for turning the light circuit on and off. Moreover, the switch has a fluorescent condition such that the switch is visible in a darkened environment.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to luminous switch devices and more particularly pertains to a new luminous switch device for illuminating a light switch in a darkened room.

### (2) Description of Related Art Including Information Disclosed Under 37 CFR 1.97 and 1.98

The prior art relates to luminous switch devices.

### BRIEF SUMMARY OF THE INVENTION

An embodiment of the disclosure meets the needs presented above by generally comprising a wall plate that is mountable to a wall having the wall plate being aligned with a switch opening in the wall. A switch is positionable in the switch opening and the switch is wired into a light circuit for turning the light circuit on and off. Moreover, the switch has a fluorescent condition such that the switch is visible in a darkened environment.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a front perspective view of a luminous light switch assembly according to an embodiment of the disclosure.

FIG. 2 is a front view of an embodiment of the disclosure.

FIG. 3 is a perspective in-use view of an embodiment of the disclosure.

FIG. 4 is a perspective view of an alternative embodiment of the disclosure.

### DETAILED DESCRIPTION OF THE INVENTION

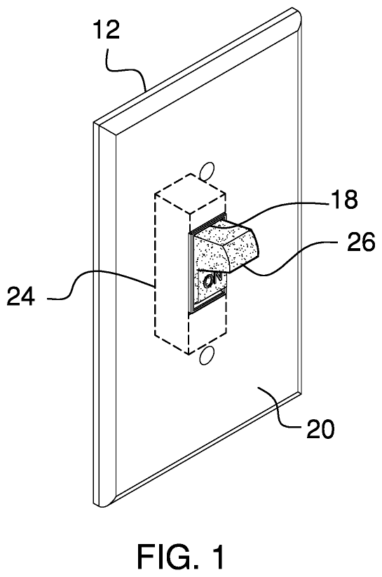

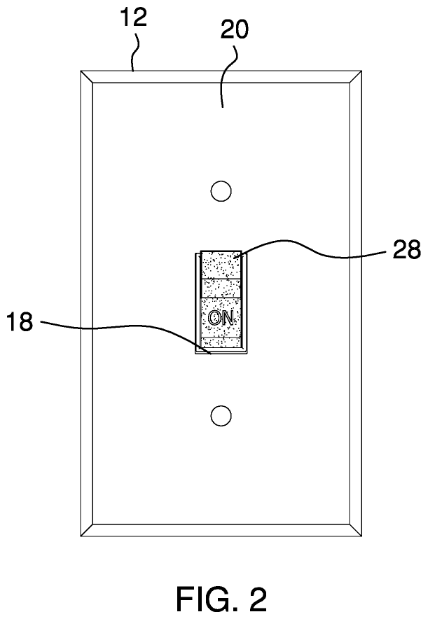

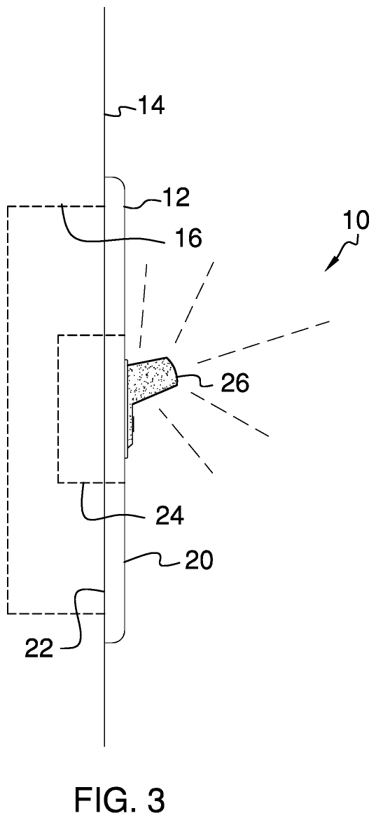

With reference now to the drawings, and in particular to FIGS. 1 through 4 thereof, a new luminous switch device embodying the principles and concepts of an embodiment of the disclosure and generally designated by the reference numeral 10 will be described.

As best illustrated in FIGS. 1 through 4, the luminous light switch assembly 10 generally comprises a wall plate 12 that is mountable to a wall 14 having the wall plate 12 being aligned with a switch opening 16 in the wall 14. The wall 14 may be a wall of a building that defines a room in the building and the switch opening 16 may be for a light switch 24 in the room. The wall plate 12 has a toggle opening 18 therein. The wall plate 12 has a front side 20 and a back side 22, and the toggle opening 18 extends through the front side 20 and the back side 22. The toggle opening 18 is centrally positioned on the wall plate 12 and the wall plate 12 is comprised of a non-fluorescent material.

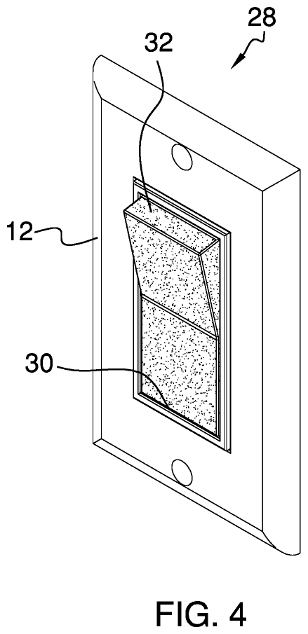

A switch 24 is provided that is positionable in the switch opening 16. The switch 24 is wired into a light circuit for turning the light circuit on and off. The switch 24 includes a toggle 26 that is positionable between an off position and an on position. The toggle 26 is comprised of an electrically insulating material thereby protecting a user from the risk of electrical shock. The electrically insulating material may comprise rubber, silicone or other similar material that is not only electrically insulating, but resiliently compressible as well. Moreover, the toggle 26 is comprised of a fluorescent material thereby facilitating the toggle 26 to be visible in a darkened environment. In this way the toggle 26 facilitates the user to locate the toggle 26. The toggle 26 extends through the toggle opening 18 in the wall plate 12 when the wall plate 12 is positioned over the switch opening 16. In an alternative embodiment 28 as is most clearly shown in FIG. 4, the wall plate 12 has a rocker opening 30 and the switch 24 includes a rocker 32 that extends through the rocker opening 30. The rocker 32 may be comprised of the same material as the toggle 26.

In use, the wall plate 12 and the switch 24 are installed on the wall 14 to serve as a switch in the light circuit. The fluorescent properties of the toggle 26 facilitate the user to locate the toggle 26 when the room is dark. In this way the user can turn on the light circuit in the room without struggling to locate the toggle 26. Additionally, the electrically insulating properties of the toggle 26 minimize the risk of electrical shock posed to the user.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

1. A luminous light switch assembly being configured to be visible in a darkened environment for turning a light on, said assembly comprising:
a wall plate being mountable to a wall having said wall plate being aligned with a switch opening in the wall; and
a switch being positionable in the switch opening wherein said switch is configured to be wired into a light circuit for turning the light circuit on and off, said switch having a fluorescent condition wherein said switch is configured to be visible in a darkened environment, said switch including a toggle being positionable between an off position and an on position, said toggle being comprised of a fluorescent material wherein said toggle is configured to be visible in a darkened environment thereby facilitating a user to locate said toggle; and
raised indicia positioned on a surface of said toggle, said raised indicia being shaped to form the word “ON”, said raised indicia being positioned to be exposed when said toggle is in the on position.

2. The assembly according to claim 1, wherein said wall plate has a toggle opening therein, said wall plate having a front side and a back side, said toggle opening extending through said front side and said back side, said toggle opening being centrally positioned on said wall plate, said wall plate being comprised of a non-fluorescent material.

3. (canceled)

4. The assembly according to claim 2, further comprising said toggle extending through said toggle opening in said wall plate when said wall plate is positioned over the switch opening.

5. A luminous light switch assembly being configured to be visible in a darkened environment for turning a light on, said assembly comprising:
a wall plate being mountable to a wall having said wall plate being aligned with a switch opening in the wall, said wall plate having a toggle opening therein, said wall plate having a front side and a back side, said toggle opening extending through said front side and said back side, said toggle opening being centrally positioned on said wall plate, said wall plate being comprised of a non-fluorescent material; and
a switch being positionable in the switch opening wherein said switch is configured to be wired into a light circuit for turning the light circuit on and off, said switch having a fluorescent condition wherein said switch is configured to be visible in a darkened environment, said switch including a toggle being positionable between an off position and an on position, toggle being comprised of an electrically insulating material, said toggle being comprised of a fluorescent material wherein said toggle is configured to be visible in a darkened environment thereby facilitating a user to locate said toggle, said toggle extending through said toggle opening in said wall plate when said wall plate is positioned over the switch opening; and
raised indicia positioned on a surface of said toggle, said raised indicia being shaped to form the word “ON”, said raised indicia being positioned to be exposed when said toggle is in the on position.
